(19) United States
(12) Patent Application Publication
(10) Pub. No.: US 2013/0125809 A1
(43) Pub. Date: May 23, 2013

(54) SYSTEM FOR CHECKING OIL LEVEL

(71) Applicant: Briggs & Stratton Corporation, Wauwatosa, WI (US)

(72) Inventors: Gary Joseph Gracyalny, Elm Grove, WI (US); Kenneth R. Breitenstein, Cedarburg, WI (US); Gregory D. Irwin, Eagle, WI (US); David A. Kratz, Brookfield, WI (US); Elliot J. Matel, Milwaukee, WI (US); Jeffery P. May, Kewaskum, WI (US); David W. Procknow, Elm Grove, WI (US)

(73) Assignee: Briggs & Stratton Corporation, Wauwatosa, WI (US)

(21) Appl. No.: 13/679,915

(22) Filed: Nov. 16, 2012

Related U.S. Application Data
(60) Provisional application No. 61/561,122, filed on Nov. 17, 2011.

(51) Int. Cl. G01F 23/30

(52) U.S. Cl. CPC G01F 23/30
USPC 116/228

(57) ABSTRACT

An engine includes a crankcase defining an interior volume for containing lubricant, a fill apparatus including a fill passage and a cap removably coupled to the fill passage, the fill passage defining a main conduit through which the lubricant is provided to the interior volume, a visual interface including an indicator movable in response to an amount of the lubricant in the interior volume to indicate different amounts of the lubricant in the interior volume, a float configured to float on a surface of the lubricant, and a float rod coupling the float to the indicator so that movement of the float in response to changes in the amount of the lubricant in the interior volume causes movement of the indicator.

### CROSS-REFERENCE TO RELATED PATENT APPLICATIONS

This application claims the benefit of Application No. 61/561,122, filed Nov. 17, 2011, which is incorporated herein by reference in its entirety.

### BACKGROUND

The present application relates generally to systems for monitoring the oil level in engines. More specifically the present application relates to a system for visually checking an oil level in an engine without the use of a dipstick.

Internal combustion engines typically include an oil dipstick used to check the oil level. Many engines include an oil fill cap with a dipstick attached to an inside surface of the fill cap. To inspect the oil level, the oil fill cap and dipstick are lifted away from a fill hole and the dipstick is wiped clean, such as with a rag or paper towel. The dipstick is then reinserted into the fill hole and removed once again. Typically dipsticks have hash marks or pin holes indicative of a proper oil level. Visual inspection of oil clinging to the dipstick indicates the current oil level in the engine. If the oil level is too low, then additional oil may added.

### SUMMARY

One embodiment of the invention relates to an engine including a crankcase defining an interior volume for containing lubricant, a fill apparatus including a fill passage and a cap removably coupled to the fill passage, the fill passage defining a main conduit through which the lubricant is provided to the interior volume, a visual interface including an indicator movable in response to an amount of the lubricant in the interior volume to indicate different amounts of the lubricant in the interior volume, a float configured to float on a surface of the lubricant, and a float rod coupling the float to the indicator so that movement of the float in response to changes in the amount of the lubricant in the interior volume causes movement of the indicator.

Another embodiment of the invention relates to an engine including a crankcase defining an interior volume for containing lubricant and a visual interface including a lens at least partially defining a lens volume, the lens including a transparent face angled relative to vertical for viewing by a user from a standing position, the face including a plurality of markings, wherein the lens volume is in fluid communication with the interior volume and configured to receive a portion of the lubricant from the interior volume such that a level of the portion of the lubricant in the lens volume is visible through the lens and a position of the level relative to the markings indicates an amount of the lubricant in the interior volume and wherein the level is configured to vary in response to the amount of the lubricant in the interior volume.

Another embodiment of the invention relates to a fill apparatus for use with an engine including a crankcase defining an interior volume for containing lubricant and a fill passage through which the lubricant is provided to the interior volume. The fill apparatus includes a cap configured to be removably coupled to the fill passage, a visual interface coupled to the cap and including an indicator configured to move in response to an amount of the lubricant in the interior volume to indicate different amounts of the lubricant in the interior volume, a float configured to float on a surface of the lubricant, and a float rod coupling the float to the indicator so that movement of the float in response to changes in the amount of the lubricant in the interior volume causes movement of the indicator.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures.

FIG. 1 is a side view of an engine including an oil fill apparatus, in accordance with an exemplary embodiment.

FIG. 2 is a cross section view of the engine of FIG. 1.

FIG. 3 is perspective view of the oil fill apparatus of FIG. 1.

FIG. 4 is a front view of an oil fill apparatus, in accordance with another exemplary embodiment.

FIG. 5 is a side view of the oil fill apparatus of FIG. 4.

FIG. 6 is a side view of a float-operated switch for a visual indicator for the oil fill apparatus of FIG. 4.

FIG. 7 is a rear perspective view of a portion of an engine including an oil fill apparatus, in accordance with another exemplary embodiment.

FIG. 8 is a cross-section view of the engine of FIG. 7.

FIG. 9 is perspective view of the oil fill apparatus of FIG. 7.

FIG. 10 is a perspective view of a portion of an engine including an oil fill apparatus, in accordance with another exemplary embodiment.

FIG. 11 is a cross-section view of the engine of FIG. 10.

FIG. 12 is a detail perspective view of the oil fill apparatus for the engine of FIG. 10.

FIG. 13 is a front perspective view of the oil fill apparatus of FIG. 10.

FIG. 14 is a rear perspective view of the oil fill apparatus of FIG. 10.

FIG. 15 is a perspective view of an oil fill apparatus, in accordance with another exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

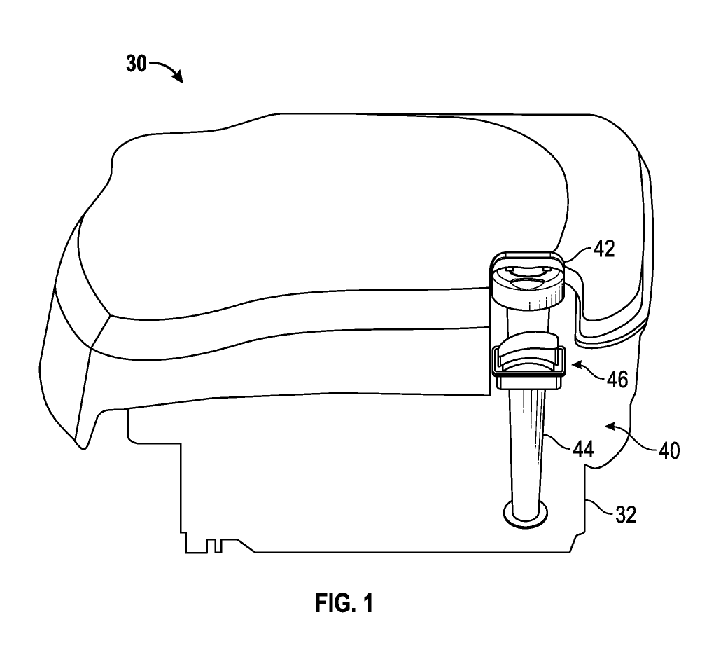

Referring to FIGS. 1-3, in an exemplary embodiment, an engine 30 is a small, single-cylinder, gasoline-powered, four-stroke cycle internal combustion engine. However a broad range of engines and other fluid holding components may benefit from the teachings disclosed herein. In some embodiments, the engine 30 is vertically shafted (as shown in FIG. 1), while in other embodiments, an engine is horizontally shafted. For example, in some contemplated embodiments, the engine may include two, three, or more cylinders, may be a diesel engine, or may have a two-stroke cycle. The engine 30 may be configured to power a broad range of equipment, including lawn mowers, pressure washers, electric generators, snow throwers, and other equipment.

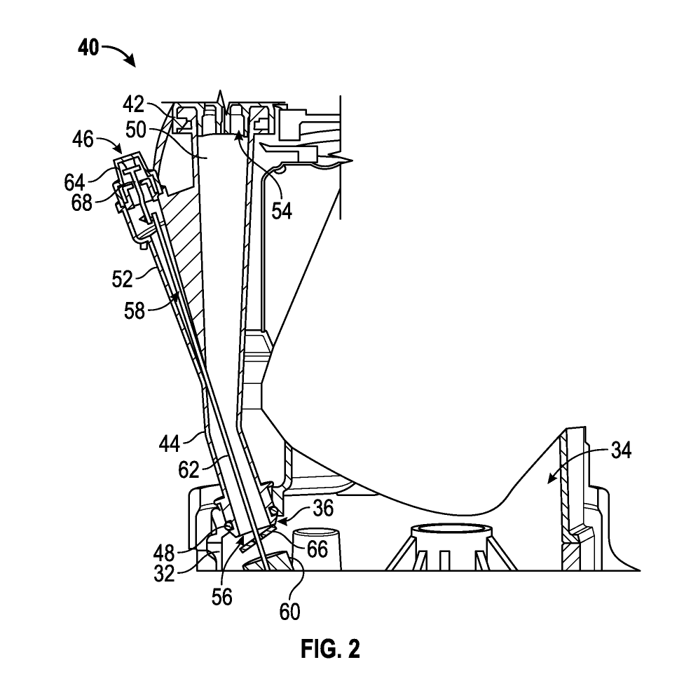

Referring to FIG. 2, the engine 30 includes a crankcase 32 defining an interior volume 34 holding a lubricant, such as motor oil. During operation of the engine 30, a piston translates back and forth within the cylinder block, powered by combustion processes. As the piston translates, a connecting rod coupled to the piston drives a crankshaft of the engine 30. In some embodiments, movement of the crankshaft facilitates spreading of the oil throughout the crankcase 32 for lubrication and cooling of the components of the engine 30, such as the piston, connecting rod, and crankshaft (not specifically shown in the figures).

Further referring to FIGS. 1-2, according to an exemplary embodiment, the engine 30 further includes an oil fill apparatus 40. The oil fill apparatus 40 includes an oil fill cap 42. The oil fill cap 42 may be removably coupled (e.g., with a threaded connection) to an oil fill passage or conduit 44 through which oil may be poured down to the crankcase 32. The oil fill passage 44 is received by an oil fill opening 36 in the crankcase 32. A sealing member 48 (e.g., o-ring, gasket, etc.) is provided between the oil fill passage 44 and the oil fill opening 36 to reduce the likelihood of oil escaping from the interior 34 through the opening 36. The oil fill apparatus 40 also includes a visual interface system 46 for checking a level of oil in the crankcase 32.

Referring to FIG. 2, the oil fill passage 44 includes a first passage 50 (e.g., main conduit, main tube, etc.) and a second passage 52 (e.g., branch conduit, branch tube, etc.). According to one exemplary embodiment, the first passage 50 extends from an inlet 54 covered by the oil fill cap 42 to an outlet 56 which opens into the interior volume 34 of the crankcase 32 at the fill opening 36. The second passage 52 branches off the first passage 50 at an angle. The second passage extends from an opening 58 through which the second passage 52 is in fluid communication with the first passage 50. The visual interface system 46 is provided at the end of the second passage 52 and is coupled to a float 60 via a float rod 62 that extends through the second passage 52 and through a portion of the first passage. The float 60 floats on the surface of the oil in the crankcase 32. According to an exemplary embodiment, the float 60 may be formed of a phenolic resin material.

Referring to FIG. 2, in some embodiments, oil fill apparatus 40 further includes a baffle or shield 66 positioned above the float 60 to at least partially shield the float 60 from oil being added to the engine 30 via the oil fill passage 40. The baffle 66 helps to prevent inaccurate positioning of the indicator 68 with respect to the actual oil level by at least partially shielding the float 60 from the stream of incoming oil, thereby preventing the stream of incoming oil from impacting the float 60 and forcing the float 60 below the oil level, which could result in the indicator 68 being positioned to indicate an oil level below the true level.

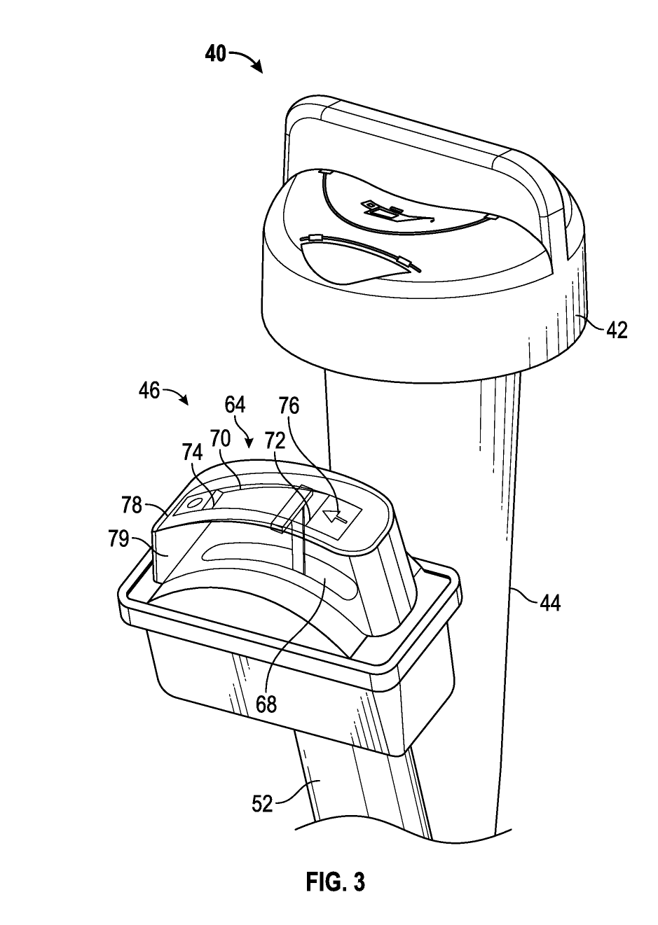

Referring to FIG. 3, the visual interface system 46 includes a transparent lens 64 with markings 70 (e.g., graduated indicia, measurement lines) corresponding to different levels of oil in the crankcase 32 and an indicator 68 that moves in relation to the level of the oil in the crankcase 32.

Referring to FIG. 2, the float rod 62 is coupled to the indicator 68 with a pivoting connection. As the float rod 62 moves upward or downward due to a changing oil level in the crankcase 32, the indicator 68 moves below the lens 64. The position of the indicator 68 relative to the markings 70 allows the viewer to see an indication of the current level of oil in the crankcase. If the current level is too low, oil may be added to the oil in the crankcase 32 through the first passage 50 of the oil fill passage 44. If the current level is too high, oil may be emptied from the crankcase through a drain hole.

A conventional dipstick system generally requires a user to add or remove a volume of oil, advance the dipstick into the crankcase 32, and remove the dipstick from the crankcase 32 to check the oil level. With the oil fill apparatus 40 described above, a user of the engine 30 may adjust the oil level (e.g., by adding oil through the inlet 54 of the first passage 50 of the oil fill passage 44 or by emptying oil from the crankcase 32) while monitoring the oil level in real time via the position of the indicator 68 relative to the markings 70. An existing engine may be retrofitted with an oil fill apparatus 40, replacing an existing oil fill tube including a conventional dipstick with the oil fill apparatus 40.

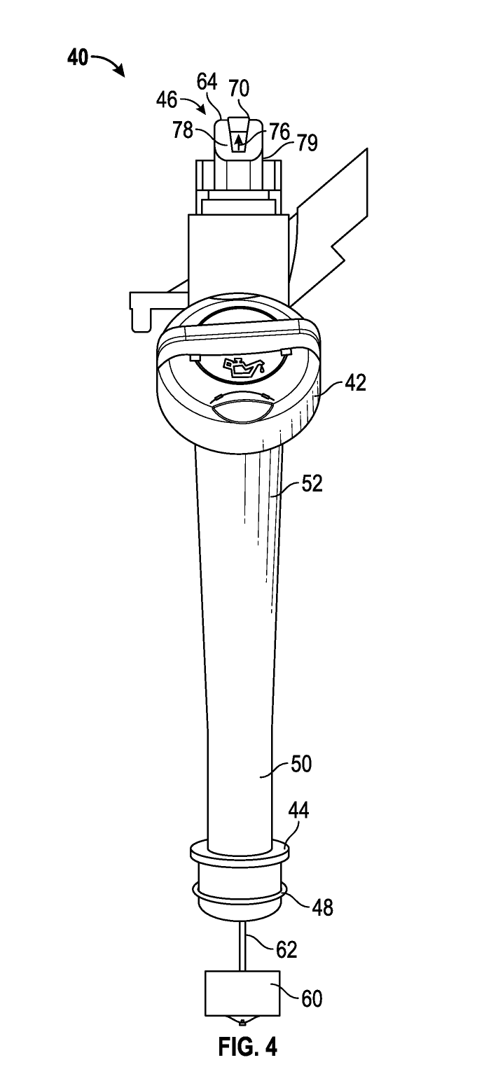

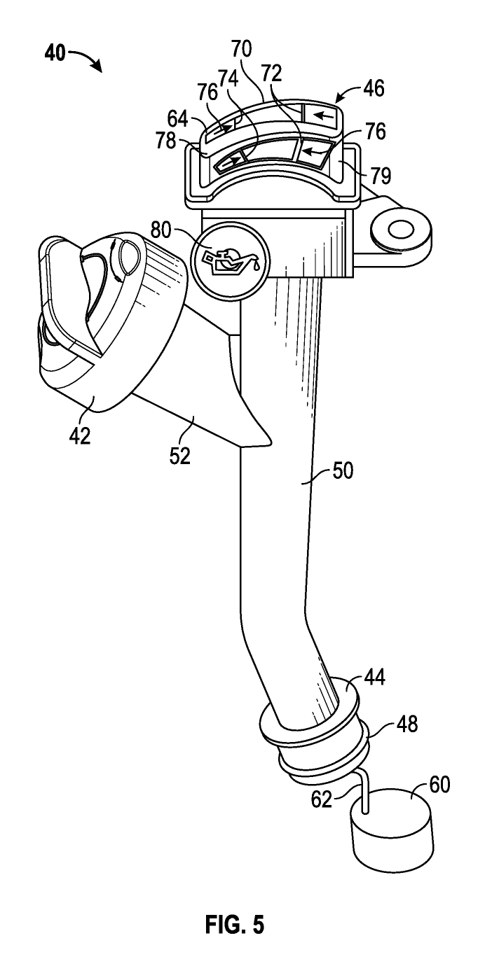

Referring now to FIGS. 4-5, an oil fill apparatus 40 is shown according to another exemplary embodiment with the positions of the oil fill cap 42 and the visual interface system 46 reversed. The oil fill cap 42 is coupled to the end of the angled second passage 52 and the visual interface system 46 is coupled to the end of the first passage 50. Positioning the oil fill cap 42 on an angle is intended to provide for easier pouring of oil from an oil bottle when adding oil to the crankcase. Also, coupling the visual interface system 46 to the end of the first passage 50 may improve visibility of the visual interface system 46 for the user by positioning the visual interface system 46 above the oil fill cap 42. The float rod 62 therefore extends through the first passage 50 and oil is added to the crankcase 32 through the second passage 52 and a portion of the first passage 50. As shown in FIG. 5, the float rod 62 includes an offset so that the float 60 is not directly underneath the opening of the oil fill passage 44. This positioning of the float 60 helps to prevent inaccurate positioning of the indicator 68 with respect to the actual oil level by at least partially preventing the stream of incoming oil from impacting the float 60 and forcing the float 60 below the oil level, which could result in the indicator 68 being positioned to indicate an oil level below the true level.

Referring especially to FIG. 5, the markings 70 of the visual interface system 46 are shown in more detail. A first or full mark 72 and a second or add oil mark 74 define a preferred range for the oil level in the crankcase 32. Marks 72 and 74 may be provided both on the top 78 of the lens 64 and/or on the sides 79 of the lens 64. The markings 70 may further include additional marks or icons, such as arrows 76. The markings 70 may make use of color to visually indicate the preferred oil level range. For instance, the markings 70 may be green in the preferred oil level range and red outside of the preferred oil level range. Additional colors may also be utilized, such as yellow intermediate markings between green markings and red markings.

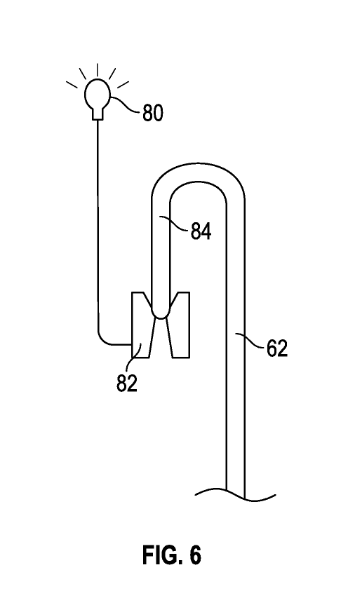

As shown in FIG. 6, the visual interface system 46 may further include an additional visual indicator, such as a status or warning light 80. In one exemplary embodiment, the light 80 is configured to illuminate when the oil level falls below a predetermined lower limit (e.g., a level below the add oil mark 74). The light 80 may be any suitable device, such as an incandescent bulb or an LED and may be located in a housing that shades the light 80 from the sun. The light 80 may be shown as an international oil can symbol, similar to the symbol used in the automotive context. The light 80 increases the likelihood that the viewer will recognize a low oil level by providing an additional visual indication. The float rod 62 may be a metallic member (e.g., an aluminum wire) and be part of a circuit controlling the warning light 80. Electrical contact 82 is positioned such that the end 84 of the float rod 62 closes the contact 82 and creates a conductive path to activate the light 80 when the oil level reaches the predetermined lower limit. The light may be steadily illuminated or may be illuminated with a blinking pattern. A circuit board including a processor may be used in conjunction with appropriate electronics to enable the different light configurations. According to various exemplary embodiments, the light may be powered by a variety of devices, such as the primary ignition coil, a secondary battery, a solar cell, etc.

According to various exemplary embodiments, even when the oil level is below the predetermined lower limit at which the light 80 would be illuminated, the light 80 may not be illuminated continuously, but may only be illuminated at certain times to reduce the amount of power used by the light 80. For example, according to one exemplary embodiment, even if the oil level is low, light 80 may not be illuminated when engine 30 is not rotating. Instead, the light 80 may only illuminate while the engine 30 is rotated during starting (e.g., via a keyswitch, a pull start, etc.). In one embodiment, after the engine has been started, the light 80 is illuminated (steady or blinking) for a period of time (e.g., one minute), and then turned off. Turning the light off after a period of time post-engine start avoids a circumstance where a false low oil condition is indicated by the light 80 during operation (e.g., when the engine is tilted, such as when the engine is used to power a lawn mower and the mower is used on steep grade). The starting of the engine 30 may therefore be utilized to “wake up” the light 80. One advantage to only operating the light 80 when the engine 30 is rotated during starting and for some time thereafter is that the light 80 may be powered using electrical current from the ignition system of the engine 30 rather than a separate battery. In certain embodiments, power from a battery or capacitor is provided to the light 80 by the activation of a switch associated with engagement of the operator presence control lever of outdoor power equipment powered by the engine 30. The operator presence control lever is typically associated with an ignition stop switch and flywheel brake and the associated switch can be used to also activate the light 80 if applicable. In another embodiment, a push-button may be used to provide power to the light 80 or the associated indicator.

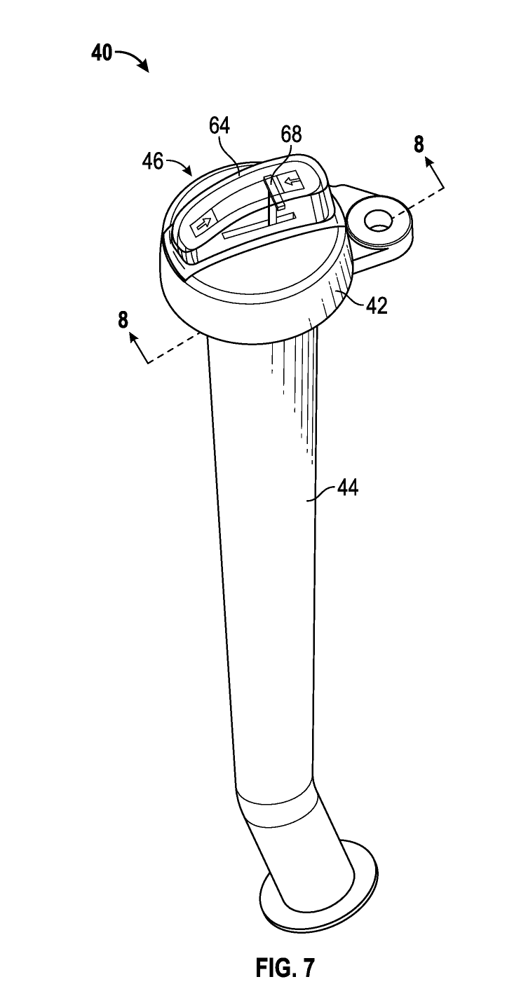

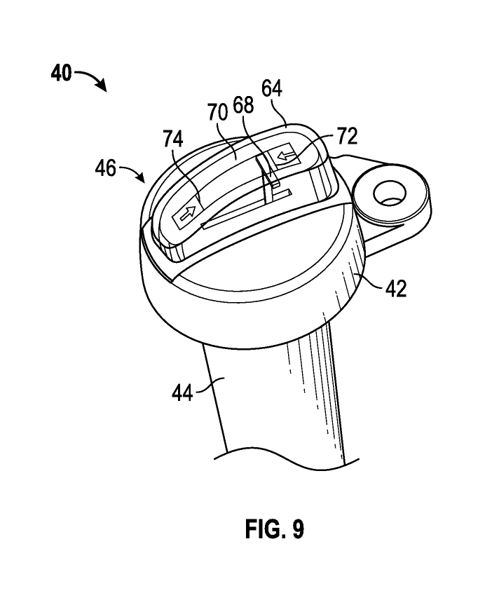

Referring now to FIGS. 7-9, according to other exemplary embodiments, the oil fill passage 44 may include a single interior passage and the visual interface system 46 may be integrated with the oil fill cap 42. As previously described, the visual interface system includes an indicator 68 provided under a transparent lens 64. A float 60 actuates the indicator 68 via a float rod 62 relative to markings 70 (see FIG. 9) on the lens 64. The lens 64 is provided on the upper surface of the oil fill cap 42 and the lens 64 and the indicator 68 are removable with the oil fill cap 42.

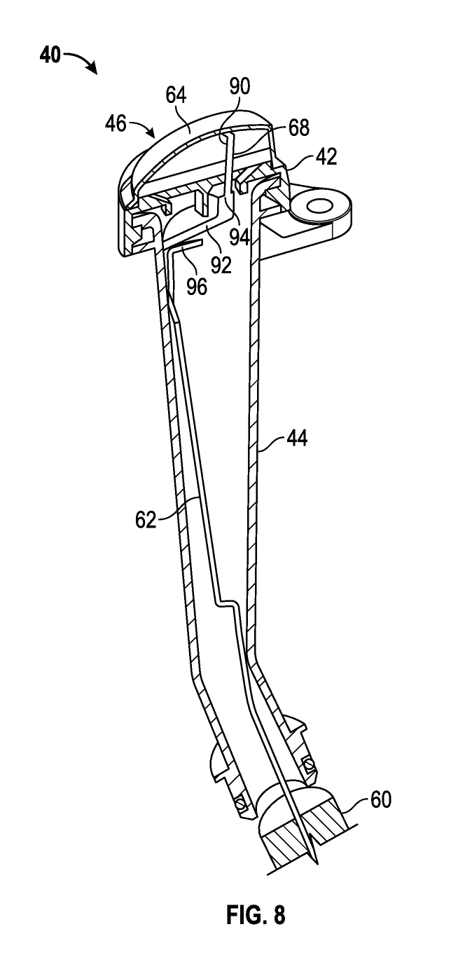

Referring to FIG. 8, according to an exemplary embodiment, indicator 68 is an L-shaped body with an upper portion or pointer 90 extending at an angle relative to a lower portion or base 92. The indicator 68 is coupled to the body of the oil fill cap 42 at a pivot point 94. The pivot point 94 may be, for example, near the vertex between the pointer 90 and the base 92. The float rod 62 includes a bent end 96 that contacts the base 92 of the indicator 68. The bent end 96 and the base 92 provide a connection between a removable portion of the visual interface system 46 (including the lens 64 and the indicator 68) and a non-removable portion of the visual interface system 46 (including the float 60 and the float rod 62).

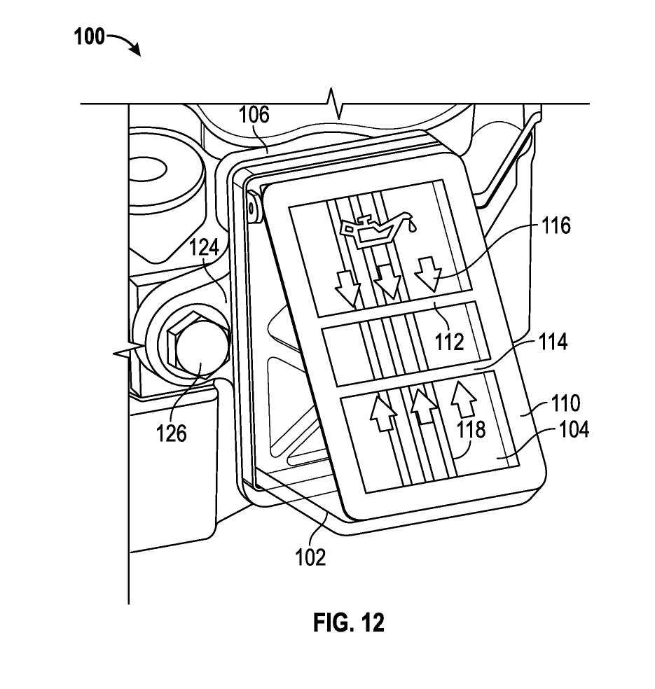

As a rising oil level in the crankcase 32 raises the float 60 and the float rod 62, the bent end 96 of the float rod 62 pushes against the base 92, forcing the indicator 68 to rotate about the pivot point 94 such that the pointer 90 moves toward the full mark 72 (see FIG. 12). A dropping oil level in the crankcase 32 decreases the level of float 60 and the float rod 62, such that the bent end 96 moves away from the base 92, allowing gravity to reduce the height of the base 92 and rotate the indicator 68 about the pivot point 94 such that the pointer 90 moves toward the add oil mark 74 (see FIG. 12).

The oil fill apparatus 40 as described in reference to FIGS. 7-9 may be configured to utilize a conventional oil fill passage 44 (with minor modifications to guide the float rod). Therefore, an existing engine may be retrofitted to include a visual interface system 46 by simply replacing the conventional oil fill cap and dipstick with the oil fill cap 42 with integrated visual interface system 46, the float 60, and the float rod 62.

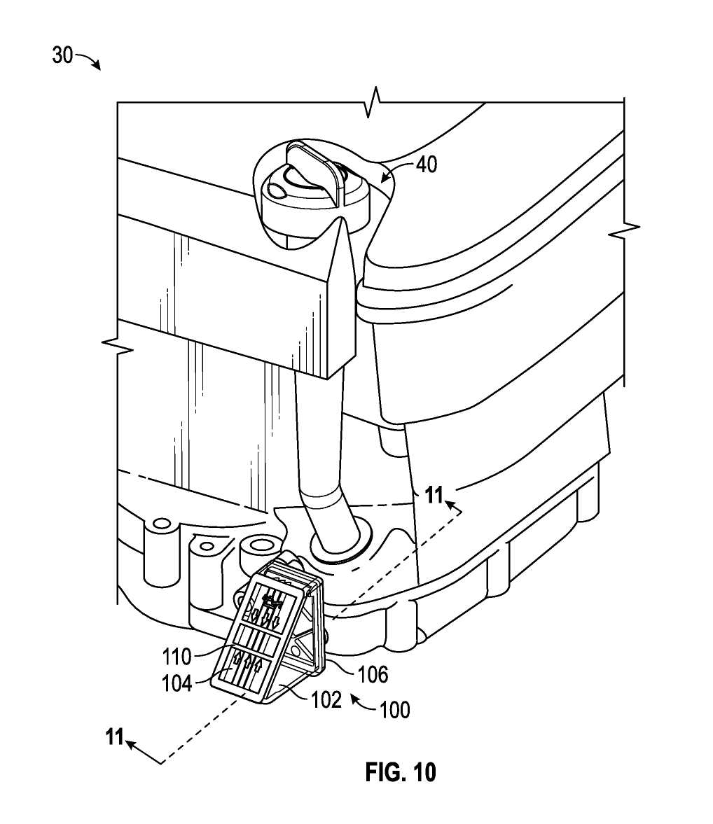

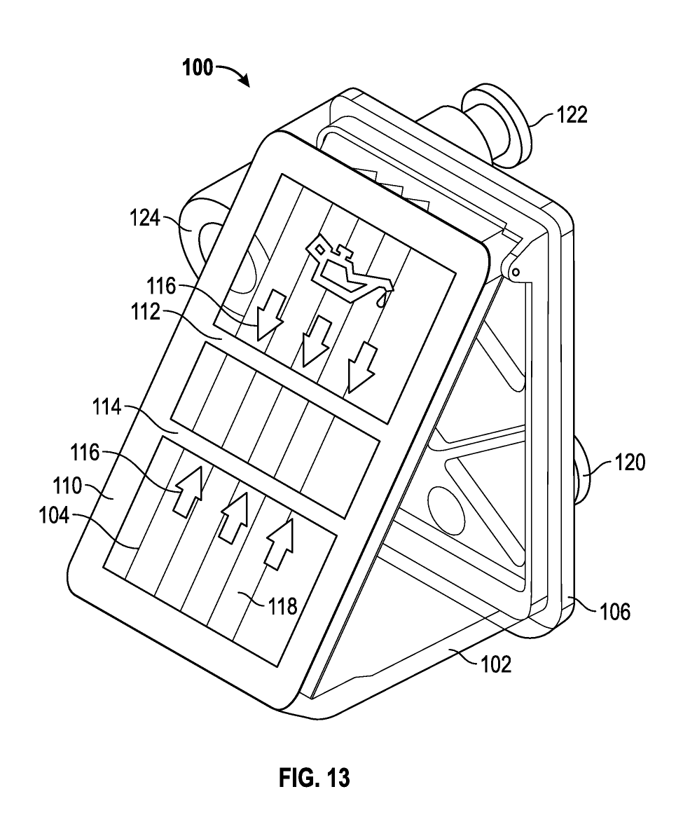

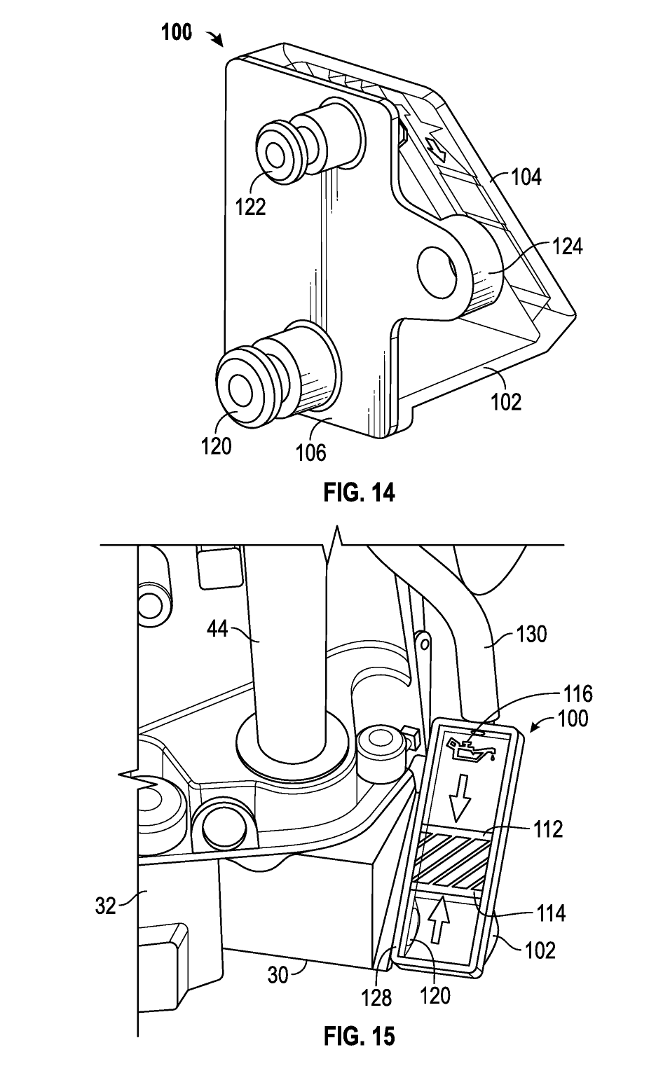

Referring now to FIGS. 10-14, an engine 30 is shown including a visual interface system 100 according to another exemplary embodiment. Visual interface system 100 is not a part of the oil fill apparatus 40. Instead, visual interface system 100 is coupled directly to the crankcase 32.

The visual interface system 100 includes a transparent lens 102 (e.g., window, viewglass, etc.) with an angled face 104 that is coupled directly to the crankcase 32 with a back plate 106. Oil is allowed to flow freely between the interior 34 of the crankcase 32 and the visual interface system 100. The oil level may be monitored by a viewer by comparing the visible oil level to reference markings 110 on the angled face 104.

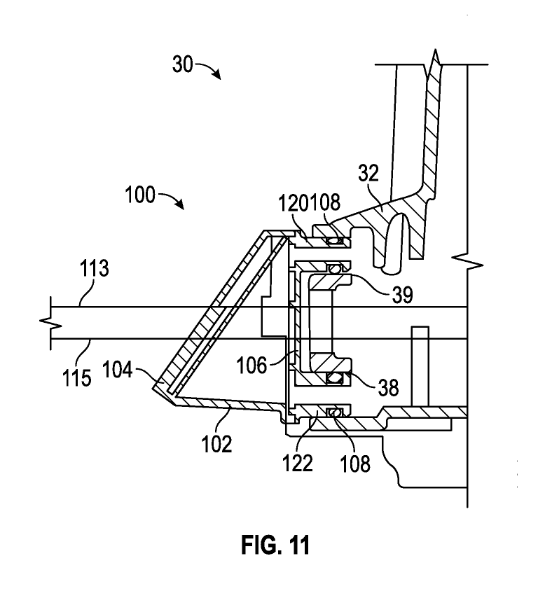

Referring to FIGS. 12-14, the visual interface system 100 is shown in more detail. According to an exemplary embodiment, the lens 102 is a hollow, triangular prismatic body. Lens 102 is preferably formed of a rigid, transparent material that is resistant to oil and heat (e.g., glass, a polymer such as acrylic or transparent nylon, etc.). The angled face 104 includes markings 110 to indicate the oil level. A first or full mark 112 corresponding to an upper level limit 113 of the oil in the crankcase 32 (see FIG. 11) and a second or add oil mark 114 corresponding to an lower level limit 115 of the oil in the crankcase 32 (see FIG. 11) define a preferred range for the oil level in the crankcase 32. The markings 110 may further include additional marks or icons such as arrows 116. The markings 110 may make use of color to visually indicate the preferred oil level range. For instance, the markings 110 may be green in the preferred oil level range and red outside of the preferred oil level range. Additional colors may also be utilized, such as yellow intermediate markings between green markings and red markings.

Referring to FIGS. 11-12, in an exemplary embodiment, the difference between the upper level limit 113 and the lower level limit 115 may be relatively small. By being provided on the angled face 104, the marks 112 and 114 on the face 104 are spaced apart an increased amount relative to the upper level limit 113 and the lower level limit 115 of the oil in the crankcase 32, thereby increasing the visual resolution of the markings 112 and 114 relative to the actual oil level in the crankcase 32. Further, the angled face 104 allows the oil level to be more easily read by an user from a standing position. The angled face 104 is angled from vertical, where vertical is the direction of gravity. The angle relative to vertical may vary. In some embodiments, the angle relative to vertical is between about 30 degrees and about 45 degrees.

To further increase the visibility of the oil in the visual interface system 100, the angled face 104 of the lens 102 may be similar to a reflex glass gauge and include a plurality of prismatic grooves or ribs 118 (e.g., grooves with a section angle of 90 degrees). The prismatic grooves 118, along with the refractive properties of the oil and of air to create an increased contrast indicating the oil level. Light rays from an illumination source that strike the prismatic grooves 118 below the oil level pass through and are not reflected. Light rays from an illumination source that strike the prismatic grooves 118 above the oil level are reflected back out of the lens 102. Therefore, the prismatic grooves cause the angled face to appear relatively dark below the oil level and bright (e.g., a bright silver color) above the oil level. Additionally, a colored panel or plate may be provided behind the angled face. Light striking below the oil level therefore passes through to be reflected back by the colored panel and the reflected color may be utilized as an additional indicator for the view. For example, the panel may be colored green in the target range between the upper mark 112 and the lower mark 114 and may be colored red in the areas outside of the target range (e.g., above the upper mark 112 and below the lower mark 114). While only a portion of the angled face 104 is shown to include prismatic grooves 118 in the figures, in other embodiments, the entire angled face 104 may include prismatic grooves.

The back plate 106 is coupled to the lens 102 (e.g., welded) to form a hermetic seal. The back plate 106 couples the lens 102 to the crankcase 32 and provides apertures or openings through which air and oil may pass between the interior of the visual interface system 100 and the interior of the crankcase 32. According to an exemplary embodiment, the back plate includes a lower port 120 (e.g., inlet, opening, channel, conduit, etc.) and an upper port 122 (e.g., outlet, opening, channel, conduit, etc.). The lower port 120 and the upper port 122 are received in openings 38 and 39 in the crankcase, respectively (see FIG. 11). Each of the lower port 120 and the upper port 122 may be equipped with sealing elements 108 (e.g., o-rings, gaskets, etc.) to provide a seal between the back plate 106 and the crankcase 32. Additional sealing elements may be provided, for example, about the periphery of the back plate 106 or between the back plate 106 and the lens 102.

Oil from the crankcase 32 can flow freely into and out of the visual interface system 100 through the lower port 120. The upper port 122 acts as a vent to allow air above the oil level to escape the interior of the visual interface system 100. The upper port 122 is located above the expected maximum oil level in the crankcase 32 so that oil is unlikely to enter the visual interface system 100 through the upper port 122, even when oil is being added via the fill passage 44. This helps to ensure that the oil level indicated by the visual interface system 100 is accurate. In other exemplary embodiments, the upper port 122 may not open back into the interior of the crankcase 32. Instead, the upper port 122 may open into another volume, such as into the oil fill apparatus, into a tube housing the dipstick, or to the atmosphere through a filter (e.g., a sintered metal filter).

While only a single lower port 120 and upper port 122 are shown in the figures, other exemplary embodiments may include additional ports. The ports may be cylindrical, as shown in the figures, or otherwise shaped.

Further referring to FIGS. 12-14, The back plate 106 further includes an outwardly extending flange 124. The flange 124 may be coupled to the crankcase 32 with a fastener 126. The interconnection of the fastener 126, the crankcase 32, and the flange 124, as well as the interaction of the ports 120 and 122 and the openings 38 and 39 couple the visual interface system 100 to the crankcase 32.

The visual interface system 100 may be utilized with an conventional oil fill apparatus and a conventional dipstick to provide a redundant system for monitoring the oil level of the engine.

In addition to allowing a viewer to easily see the current oil level, the lens 102 allows the viewer to visually inspect the coloration and condition of the oil.

Referring now to FIG. 15, a visual interface system 100 is shown according to another exemplary embodiment. The lower port 120 is formed in a side wall 128 of the lens 102 and the side wall 128 is coupled to the engine 30. The upper port 122 is fluidly connected to the oil fill passage 44 or another portion of the engine located above the oil level in the crankcase 32 by a vent conduit or hose 130. The upper port 122 is connected to such a portion of the engine above the expected maximum oil level in the crankcase 32 so that oil is unlikely to enter the visual interface system 100 through the upper port 122, even when oil is being added via the fill passage 44. This helps to ensure that the oil level indicated by the visual interface system 100 is accurate. This reduces the number of holes that must be formed in the crankcase 32 or engine block and returns any air vented through the upper port to the system above the oil level. The volume of the lens 102 is relatively small, which helps to ensure that a relatively large amount of oil does not need to enter the lens 102 for the indication of the oil level as shown by the markings 112, 114, and 116 to change noticeably.

The visual interface systems 46 and 100 are configured to be utilized instead of a conventional dipstick for checking the oil level. The visual interface system 46 provides an intuitive, visual, go/no-go indicator to convey to a viewer the oil level. The visual interface systems 46 and 100 may be utilized to provide an oil level indication for engines used on walk-behind or push lawn mowers, but in other contemplated embodiments, the system may be used to check fluids in other devices or to check fluids other than oil, such as antifreeze, brake fluid, water, transmission fluid, power steering fluid, windshield wiper fluid, etc. Further, the visual interface systems may be used with devices other than engines, such as refrigerators, air conditioning units, hydraulic circuits, etc

The construction and arrangements of the engine and system for checking a level of fluid in a holder of the fluid, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. Other substitutions, modifications, changes and omissions may also be made in the design, operating conditions and arrangement of the various exemplary embodiments without departing from the scope of the present invention.

What is claimed is:

1. An engine, comprising:
a crankcase defining an interior volume for containing lubricant;
a fill apparatus including a fill passage and a cap removably coupled to the fill passage, the fill passage defining a main conduit through which the lubricant is provided to the interior volume;
a visual interface including an indicator movable in response to an amount of the lubricant in the interior volume to indicate different amounts of the lubricant in the interior volume;
a float configured to float on a surface of the lubricant; and
a float rod coupling the float to the indicator so that movement of the float in response to changes in the amount of the lubricant in the interior volume causes movement of the indicator.

2. The engine of claim 1, wherein the visual interface further includes a transparent lens and a plurality of markings; and
wherein the indicator is visible through the transparent lens and each of the markings corresponds to a different amount of the lubricant in the interior volume so that a position of the indicator relative to the markings indicates the amount of the lubricant in the interior volume.

3. The engine of claim 2, wherein the visual interface is a component of the cap.

4. The engine of claim 3, wherein the float rod extends through the main conduit.

5. The engine of claim 4, wherein the fill passage further includes a baffle located at or near an end of the main conduit nearest the float.

6. The engine of claim 2, wherein the fill passage further defines a branch conduit in fluid communication with the main conduit at a first end of the branch conduit; and
wherein the float rod extends through the branch conduit and the visual interface is located at a second end of the branch conduit and the cap is removably coupled to the fill passage at a first end of the main conduit.

7. The engine of claim 6, wherein the fill passage further includes a baffle located at or near a second end of the main conduit that is between the cap and the float.

8. The engine of claim 2, wherein the fill passage further defines a branch conduit in fluid communication with the main conduit at a first end of the branch conduit; and
wherein the float rod extends through the main conduit and the visual interface is located at a first end of the main conduit and the cap is removably coupled to the fill passage at a second end of the branch conduit.

9. The engine of claim 8 wherein the fill passage further includes a baffle located at or near a second end of the main conduit that is between the visual interface and the float.

10. The engine of claim 1, wherein the visual interface further includes a light electrically coupled to an electrical contact; and
wherein the float rod closes the electrical contact, thereby activating the light, when the float is positioned to indicate that the amount of the lubricant in the interior volume is below a predetermined amount.

11. The engine of claim 1, wherein the fill passage further includes a baffle located at or near an end of the main conduit nearest the float.

12. The engine of claim 1, wherein the float is offset from an end of the main conduit nearest the float.

13. An engine, comprising:
a crankcase defining an interior volume for containing lubricant; and
a visual interface including a lens at least partially defining a lens volume, the lens including a transparent face angled relative to vertical for viewing by a user from a standing position, the face including a plurality of markings;
wherein the lens volume is in fluid communication with the interior volume and configured to receive a portion of the lubricant from the interior volume such that a level of the portion of the lubricant in the lens volume is visible through the lens and a position of the level relative to the markings indicates an amount of the lubricant in the interior volume; and
wherein the level is configured to vary in response to the amount of the lubricant in the interior volume.

14. The engine of claim 13, wherein the visual interface is secured to the crankcase.

15. The engine of claim 14, wherein the visual interface is in fluid communication with the interior volume via an upper port received by an upper opening formed in the crankcase and via a lower port received by a lower opening in the crankcase.

16. The engine of claim 14, wherein the visual interface is in fluid communication with the interior volume via a lower port received by a lower opening in the crankcase and via an upper port connected by a conduit to a portion of the engine located above the lubricant in the interior volume of the crankcase.

17. The engine of claim 13, wherein the face of the lens includes a plurality of prismatic grooves.

18. A fill apparatus for use with an engine including a crankcase defining an interior volume for containing lubricant and a fill passage through which the lubricant is provided to the interior volume, the fill apparatus comprising:
a cap configured to be removably coupled to the fill passage;
a visual interface coupled to the cap and including an indicator configured to move in response to an amount of the lubricant in the interior volume to indicate different amounts of the lubricant in the interior volume;
a float configured to float on a surface of the lubricant; and
a float rod coupling the float to the indicator so that movement of the float in response to changes in the amount of the lubricant in the interior volume causes movement of the indicator.

19. The fill apparatus of claim 18, wherein the visual interface further includes a transparent lens and a plurality of markings; and
wherein the indicator is visible through the transparent lens and each of the markings corresponds to a different amount of the lubricant in the interior volume so that a position of the indicator relative to the markings indicates the amount of the lubricant in the interior volume.

20. The fill apparatus of claim 19, further comprising a baffle located at or near an end of the fill passage nearest the float.
